(19) United States
(12) Patent Application Publication
(10) Pub. No.: US 2014/0351220 A1
(43) Pub. Date: Nov. 27, 2014

(54) CONFIGURATION OF ONE OR MORE COMPUTER DEVICES

(71) Applicant: Jeremy Debate, Boston, MA (US)

(72) Inventor: Jeremy Debate, Boston, MA (US)

(21) Appl. No.: 14/283,427

(22) Filed: May 21, 2014

Related U.S. Application Data
(60) Provisional application No. 61/826,122, filed on May 22, 2013.

(51) Int. Cl. G06F 11/14

(52) U.S. Cl. CPC G06F 11/1469
USPC 707/654

(57) ABSTRACT

An image loader resource invokes execution of a backup restoration function in a target computer device to be configured or reconfigured. The backup restoration function in the target computer device is present on the target computer device to receive a device image of data settings derived from a previously configured computer device. In furtherance of configuring the target computer device, the image loader resource retrieves a device image. According to one configuration, rather than being an actual device image obtained from a previously configured or already used computer device, the device image information is synthesized from a set of computer configuration instructions received from an administrator resource. The computer configuration instructions specify settings to be applied to the target computer device. The image loader resource communicates the synthesized device image information to the backup restoration function on the target computer device to configure the target computer device.

### RELATED APPLICATIONS

This application is related to and claims the benefit of earlier filed U.S. Provisional Patent Application Ser. No. 61/826,122 entitled “CONFIGURATION OF ONE OR MORE COMPUTER DEVICES,” (Attorney Docket No. APP13-01p), filed on May 22, 2013, the entire teachings of which are incorporated herein by this reference.

### BACKGROUND

Computer software has been developed to perform restoration of computer data originally stored on a computer device in the event that the computer device experiences a failure. For example, according to conventional techniques, a user can create a current disk image of the computer device and store the disk image for possible later use. In general, a disk image is a snapshot in time of the complete contents and structure of data (e.g., files, configuration settings, etc.) stored on a disk of the computer device.

Subsequent to creating the backup disk image of the computer device, the computer device may fail for any number of reasons. For example, the computer device may be infected with a software virus that corrupts stored data, rendering the computer device unusable. As another example, the computer device may experience a storage failure in which the computer device fails to properly store data, and so on.

To recover from a failure, the user of the computer device can restore the computer device to its original state using the previously generated backup disk image. For example, to restore the computer device back to a functional state again, the user can initiate execution of appropriate restoration software. According to one conventional use, the restoration software obtains a copy of the disk image and restores original settings and data on the computer device using the disk image. Accordingly, the computer device can be restored to its original settings.

As an alternative to using a backup file, conventional computer devices can be configured using a configuration tool. For example, an administrator can receive a used or new computer device. As an alternative to manually configuring the new computer device, the administrator can execute a configuration application on an auxiliary computer device or embedded system to configure the new or used computer device. Typically, the computer device being configured is coupled to the auxiliary computer device via communication link. Via communications over the communication link, the auxiliary computer configures the new or used computer device.

### BRIEF DESCRIPTION OF DIFFERENT EMBODIMENTS

Embodiments herein deviate with respect to conventional techniques. For example, one embodiment herein includes a novel way of configuring one or more computer devices using a backup restoration function.

More specifically, in accordance with one embodiment, an image loader resource invokes execution of a backup restoration function in a target computer device to be configured. In furtherance of configuring the target computer device, the image loader resource retrieves a device image (i.e., device image information). In one embodiment, rather than being an actual device image obtained from data stored on an already used or configured computer device, the device image information is synthesized from a set of computer configuration instructions specifying the desired settings of a target computer device.

The image loader resource communicates the synthesized device image information to the backup restoration function on the target computer device to configure the target computer device. Accordingly, embodiments herein can include configuring a respective computer device with a synthesized device image as opposed to configuring the computer device with an actual device image obtained from a previously configured computer.

The device image information as discussed herein can be produced based on input received from an administrator resource (e.g., a human administrator, machine administrator, network administrator, etc.) specifying settings to be applied to the target computer device. For example, an administrator can operate a graphical user interface to input instructions how to configure the target computer device. The target computer device can be one of multiple computer devices to be configured with respective synthesized device image information.

In one embodiment, a processor resource analyzes the input of the graphical user interface and converts the input into a set of computer configuration instructions based on the input. Thus, embodiments herein can include deriving the set of computer configuration instructions from data inputted by a network administrator through a graphical user interface.

In accordance with yet further embodiments, an image creator resource can be configured to receive the set of computer configuration instructions. The image creator resource converts the set of computer instructions into the synthesized device image information. The image creator resource creates the synthesized device image information in a manner as specified by the set of computer configuration instructions (as derived from input from administrator resource).

If desired, device image information derived from instructions inputted by an administrator can be used to simultaneously configure multiple computer devices. For example, the image loader resource can be an algorithm executing on a respective host computer device. The host computer device can be configured to establish a communication link or session with each of multiple computer devices to be configured. As mentioned, the computer device to be configured may be new or used devices.

In one non-limiting example embodiment, to simultaneously configure the computer devices, the image loader resource in the host computer device invokes execution of a respective backup restoration function in each of multiple target computer devices. The image loader resource then communicates the synthesized device image information to each of the respective backup restoration functions. In one embodiment, the image loader may make device-specific modifications to the device image information (such as to include a unique device name, unique address, etc.) such that the device image information for each of multiple computer devices is largely the same except for one or more modifications that customize the device image information for each particular target computer device.

Each of the respective backup restoration functions uses the received synthesized device image information to configure the respective computer device.

In one embodiment, the respective backup restoration function in a corresponding target computer device applies the synthesized device image information to the corresponding target computer device to modify the current settings of the corresponding target computer device. In this manner, each of multiple computer devices can be configured in a similar manner using synthesized device image information.

Further embodiments herein can include spoofing the backup restoration function in a respective target computer device that the synthesized device image information is a backup device image to be applied to the target computer device. For example, as mentioned, the image loader resource can be configured to invoke execution of the backup restoration function in the target computer device. Via proper formatting of synthesized device image information by the image creator resource, the backup restoration function in the target computer device may be spoofed into believing that the synthesized device image information represents a backup image to return the target computer device to a previous state. However, as discussed herein, although the synthesized device image information appears to be a backup image of a previously configured device, the synthesized device image information can represent new configuration settings to be applied to the target computer device(s) as specified by the administrator. Accordingly, a backup function can be used to configure a respective computer device with new computer settings.

Reconfiguring one or more target computer devices with the synthesized device image information as discussed herein resets the target computer devices to a desired state.

In an additional embodiment, the entirety of the device image information could consist solely of an MDM (Mobile Device Management) or MAM (Mobile Application Management) enrollment profile and/or supervision settings. Further installation of applications/configurations of settings can then be performed over-the-air (OTA), reducing the amount of time each device must remain tethered to the host machine. Such a tool would be an automated way of ‘bootstrapping’ the device for further application management and configuration by another type of system such as an MDM server. Embodiments herein may be useful in an environment such as an organization employing relatively large-scale distribution or redistribution of computers. For example, an administrator resource of an organization overseeing use of one or more target computer devices can produce the set of computer configuration instructions specifying the settings to be applied to the one or more target computer device. Subsequent to generating the synthesized device image information from the set of computer configuration instructions, the administrator or other suitable resource operates the image loader resource to configure or reconfigure one or more already configured computer devices.

Subsequent to communicating the synthesized device image information to the backup restoration function on the target computer device(s), any suitable resource such as the image loader resource, the backup restoration function executing on the target computer device, etc., initiates a reboot of the target computer device to activate the settings as specified by the newly applied device image information. Accordingly, embodiments herein can include configuring a respective target computer device and then rebooting the target computer device.

These and other embodiments are discussed in more detail below.

As mentioned above, note that embodiments herein can include a configuration of one or more computerized devices, workstations, handheld or laptop computers, personal computers, or the like to carry out and/or support any or all of the method operations disclosed herein. In other words, one or more computerized devices or processors in a resource such as a mobile computer device can be programmed and/or configured to operate as explained herein to carry out different embodiments of the invention.

Yet other embodiments herein include software programs to perform the steps and operations as discussed herein. One such embodiment comprises a computer program product including a non-transitory computer-readable storage medium (i.e., any suitable computer readable hardware storage medium, not a carrier wave) on which software instructions are encoded for subsequent execution. The instructions, when executed in a computerized device having a processor, program and/or cause the processor to perform the operations disclosed herein. Such arrangements are typically provided as software, code, instructions, and/or other data (e.g., data structures) arranged or encoded on a non-transitory computer readable storage medium (i.e., any computer readable hardware storage media) such as an optical medium (e.g., CD-ROM), floppy disk, hard disk, memory stick, etc., or other medium such as firmware or microcode in one or more ROM, RAM, PROM, etc., or as an Application Specific Integrated Circuit (ASIC), etc. The software or firmware or other such configurations can be installed on a computerized device to cause the computerized device to perform the techniques explained herein.

Accordingly, one particular embodiment of the present disclosure is directed to a method and computer program product that includes a computer readable hardware storage medium having instructions stored thereon. For example, in one embodiment, the instructions, when executed by one or more processor devices in a computer system such as a mobile computer device, cause the one or more processor devices to: invoke a backup restoration function on a target computer device; retrieve device image information, the device image information synthesized from a set of computer configuration instructions specifying settings of a target computer device; and communicate the synthesized device image information to the backup restoration function on the target computer device.

The ordering of the steps has been added for clarity sake. These steps can be performed in any suitable order.

Other embodiments of the present disclosure include software programs and/or respective hardware to perform any of the method embodiment steps and operations summarized above and disclosed in detail below.

It is to be understood that each of the multitude of systems, methods, apparatuses, instructions on computer readable storage media, etc., as discussed herein can be embodied strictly as a software program, as a hybrid of software and hardware, or as hardware alone such as within a processor, or within an operating system or a within a software application.

Additionally, although each of the different features, techniques, configurations, etc., herein may be discussed in different places of this disclosure, it is intended that each of the concepts can be executed independently of each other or, where suitable, the concepts can be used in combination with each other. Accordingly, the one or more present inventions as described herein can be embodied and viewed in many different ways.

Also, note that this preliminary discussion of embodiments herein does not specify every embodiment and/or incrementally novel aspect of the present disclosure or claimed invention(s). Instead, this brief description only presents general embodiments and corresponding points of novelty over conventional techniques. For additional details and/or possible perspectives (permutations) of the invention(s), and additional points of novelty, the reader is directed to the Detailed Description and Further Summary of Embodiments section and corresponding figures of the present disclosure as further discussed below.

### BRIEF DESCRIPTION OF THE DRAWINGS

FIG. 1 is an example diagram illustrating a processing environment according to embodiments herein.

FIG. 2 is an example diagram illustrating a graphical user interface according to embodiments herein.

FIG. 3 is an example diagram illustrating synthesized device image information according to embodiments herein.

FIG. 4 is an example diagram illustrating a manifest file and corresponding metadata according to embodiments herein.

FIG. 5 is an example diagram illustrating configuration of a respective target computer device according to embodiments herein.

FIG. 6 is an example diagram illustrating configuration of a respective target computer device according to embodiments herein.

FIG. 7 is an example diagram illustrating configuration of a respective target computer device according to embodiments herein.

FIG. 8 is an example diagram illustrating configuration of a respective target computer device according to embodiments herein.

FIG. 9 is an example diagram illustrating an example computer architecture for implementing functionality according to embodiments herein.

FIG. 10 is a flowchart illustrating an example method of configuring one or more target computer devices according to embodiments herein.

The foregoing and other objects, features, and advantages of the invention will be apparent from the following more particular description of preferred embodiments herein, as illustrated in the accompanying drawings in which like reference characters refer to the same parts throughout the different views. The drawings are not necessarily to scale, with emphasis instead being placed upon illustrating the embodiments, principles, concepts, etc.

### DETAILED DESCRIPTION AND FURTHER SUMMARY OF EMBODIMENTS

In accordance with embodiments herein, an image loader resource invokes execution of a backup restoration function in a target computer device to be configured or reconfigured. The backup restoration function in the target computer device is present on the target computer device to receive a device image of data settings derived from a previously configured computer device. In furtherance of configuring the target computer device, the image loader resource executing on a host computer device retrieves a synthesized device image. According to one configuration, rather than being an actual device image obtained from a previously configured or already used computer device, the device image information is synthesized from a set of computer configuration instructions received from an administrator resource. An image creator resource produces the device image information to appear as though the device image information was generated from a computer device configured with configuration information in a manner as specified by the set of computer configuration instructions. The computer configuration instructions specify settings to be applied to the target computer device. The image loader resource communicates the synthesized device image information to the backup restoration function on the target computer device to configure the target computer device.

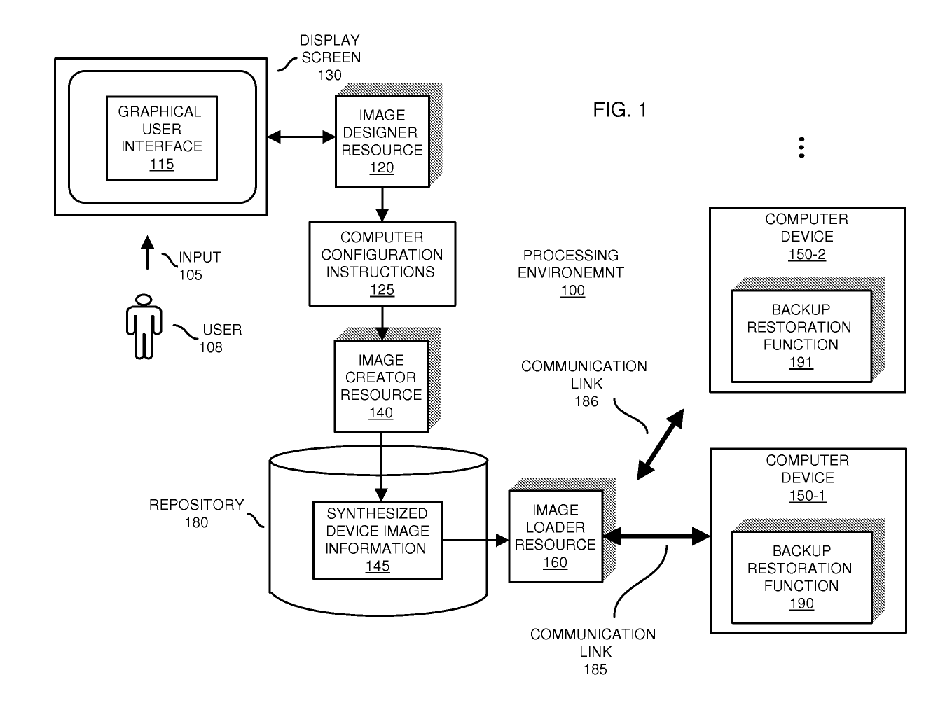

Now, more specifically, FIG. 1 is an example diagram illustrating a processing environment according to embodiments herein.

As shown, processing environment 100 includes user 108 such as a computer device administrator, display screen 130, image designer resource 120, computer configuration instructions 125, image creator resource 140, repository 180, image loader resource 160, and computer devices 150 (e.g., computer device 150-1, computer device 150-2, etc.).

User 108 (or other suitable resource) provides input 105 to graphical user interface 115. Via input 105, the user specifies settings to be applied to the one or more target computer devices. For example, a user 108 such as an administrator can operate a graphical user interface 115 to input instructions how to configure one or more target computer devices 150.

As further shown, a processor resource such as image designer resource 120 analyzes the input 105 to the graphical user interface 115 and converts the input 105 into a set of computer configuration instructions 125. Thus, the image designer resource 120 derives the set of computer configuration instructions 125 from data inputted by a computer administrator through graphical user interface 115.

As mentioned, processing environment 100 also includes an image creator resource 140. The image creator resource 140 receives the set of computer configuration instructions 125 produced by image designer resource 120. In one non-limiting example embodiment, the image creator resource 125 converts the set of computer instructions 125 into synthesized device image information 145 and stores such information in repository 180. The image creator resource 140 creates the synthesized device image information 145 in a manner as specified by the set of computer configuration instructions 125.

Note that each of the target computer devices 150 can be a new, yet-to-be used computer device that has not yet been configured for use. In this instance, configuring one or more target computer devices with the synthesized device image information 145 sets the target computer devices 150 to a desired state for subsequent use.

Alternatively, note that any of one or more of the target computer devices also may be previously configured devices that were used by respective users. In the latter instance, reconfiguring one or more target computer devices with the synthesized device image information 145 resets the target computer devices 150 back to a desired state.

In one embodiment, to simultaneously configure the computer devices, the image loader resource 160 in a respective host computer device having access to repository 180 invokes execution of a respective backup restoration function in each of multiple target computer devices. For example, to configure one or more respective target computer devices 150 using synthesized device image information 145, the image loader resource 160 communicates over communication link 185 (any suitable communication link such as a wired Universal Serial Bus cable, wireless communication link, etc.) to invoke execution of backup restoration function 190 in target computer device 150-1 to be configured; the image loader resource 160 communicates over communication link 186 to invoke execution of backup restoration function 191 in target computer device 150-2 to be configured; and so on.

Over a respective communication link, the image loader resource 160 then communicates the synthesized device image information 145 over a respective communication link to each of the respective backup restoration functions 190, 191, etc. Each of the respective backup restoration functions 190, 191, etc., uses the synthesized device image information 145 to configure the respective computer device.

More specifically, in furtherance of configuring the target computer devices 150, the image loader resource 160 retrieves synthesized device image information 145. In one embodiment as discussed above, rather than being an actual device image obtained from data stored on an already used or configured computer device, the synthesized device image information 145 is synthesized from input 105. In other words, the synthesized device image information 145 represents settings as specified by the input 105 as opposed to being a backup image derived from an already configured computer device. The image creator resource 140 produces the synthesized device image information 145 to appear as though it represents configuration information and respective data previously installed a computer device.

In one embodiment, the image creator resource 140 (executing on a respective computer device) receives one or more software installation package of respective executable applications to be installed on a respective target device (such as computer device 150-1, computer device 150-2, etc.). The image creator resource 140 (remotely located with respect to the target computer devices 150-1, 150-2, etc., on which respective synthesized device image information will be subsequently downloaded/installed) executes the one or more software installation packages locally to install the one or more applications (executable files and related information) and create an initial device image. The image creator resource 140 uses the installed executable files and related information associated with the initial device image to produce the synthesized device image information 145. For example, as described herein, the image creator resource 140 can be configured to further customize the locally installed executable files and related application information to produce synthesized device image information 145 in accordance with computer configuration instructions 125. In this manner, the respective synthesized device image information 145 is customized on behalf of a respective user of the target computer device for which the synthesized device image information 145 is destined.

In contrast to creating synthesized device image information 145 for installing one or more applications onto a target computer device as described herein, conventional techniques in the art require that the target computer device execute an installation package to install a respective application onto the target computer device.

The image loader resource 160 (such as executing on a respective host computer having access to repository 180) communicates the synthesized device image information 145 to the backup restoration function 190 on the target computer device 150-1 to configure the target computer device 150-1.

In one embodiment, the respective backup restoration function 190 in a corresponding target computer device 150-1 applies the synthesized device image information 145 to the corresponding target computer device to modify respective current settings of the corresponding target computer device. For example, backup restoration function 190 uses the synthesized device image information 145 for installation to a storage resource of computer device 150-1. In a similar manner, the image loader resource 160 can be configured to configure each of multiple computer devices 150 using synthesized device image information 145.

Note that embodiments herein can include spoofing the backup restoration function 190 in a respective target computer device that all or a portion of the synthesized device image information 145 is a backup device image to be applied to the target computer device 150-1.

As a more specific example, as mentioned, the image loader resource 160 can be configured to invoke execution of the backup restoration function 190 in the target computer device 150-1. Via proper formatting of synthesized device image information 145 by the image creator resource 140, the backup restoration function in the target computer device is spoofed into believing that the synthesized device image information 145 represents a previously created backup image to return the target computer device to a previous state. In other words, the synthesized device image information 145 is formatted in a manner so that it appears to the respective backup restoration function that the synthesized device image information 145 is an actual backup image applied to a device. However, as discussed herein, although the synthesized device image information 145 appears to be a backup image of a previously configured device, the synthesized device image information 145 can represent new configuration settings to be applied to the target computer device(s) as specified by the administrator resource (e.g., user 108, machine, etc.).

Subsequent to communicating the synthesized device image information 145 to the backup restoration function(s), the image loader resource 160 or the backup restoration function executing on the target computer device initiates a reboot of the target computer device to activate the settings as specified by the synthesized device image information 145. Accordingly, embodiments herein can include configuring a respective target computer device and then rebooting the target computer device.

Embodiments herein may be useful in any environment such as organizations employing relatively large-scale distribution or redistribution of computers. For example, an administrator resource such as user 108 of an organization overseeing use of one or more target computer devices 150 can produce the set of computer configuration instructions 125 specifying the settings to be applied to the one or more target computer device 150. The set of computer configuration instructions 125 may not be in an appropriate format to configure a respective computer device.

Subsequent to the image designer resource 120 generating the synthesized device image information 145 from the set of computer configuration instructions 125, the administrator or other suitable resource operates the image loader resource 160 to configure or reconfigure one or more computer devices 150.

An example in which reconfiguration of one or more computer devices is useful is an airline that rents or otherwise loans the computer devices for temporary use to passengers. During a flight, the users of the computer devices may adjust settings of the devices. For example, the users may download and install applications to a respective computer device; a user may modify a layout of icons on a respective computer device; a user may download personal information to a respective computer device, etc. In this non-limiting example embodiment, after the flight reaches its destination and the passengers return the computer devices, the airline personnel can initiate loading of the synthesized device image information 145 to the computer devices to set them back to their original (newly configured) state again. Accordingly, the next passenger that uses the computer device on the airplane will use a freshly configured device.

As previously discussed, note again that the entirety of the device image information could consist solely of an MDM (Mobile Device Management) or MAM (Mobile Application Management) enrollment profile and/or supervision settings to be installed and/or downloaded on a target device. Further installation of applications/configurations of settings can then be performed over-the-air (OTA), reducing the amount of time each device must remain tethered to the host machine. Such a tool would be an automated way of ‘bootstrapping’ the device for further application management and configuration by another type of system such as an MDM server.

As a more specific example, the functionality associated with image loader resource 160 can be executed in a host computer device in communication with a respective computer device. Assume that the computer device 150-1 is the target device in this example. To retrieve software updates, the computer device 150-1 communicates with a host computer that executes image loader resource 160. The host computer device executing the image loader resource 160 communicates over a network (such as the Internet) with a management server resource that manages all or a part of the applications that execute on a respective target computer device.

Assume that a network administrator controlling all or a portion of applications associated with computer device 150-1 wishes to install a new application onto computer device 150-1. In such an instance, the host computer device executing image loader resource 160 communicates with the management server to retrieve synthesized device image information 145. As previously discussed, the synthesized device image information can include a customized application to be installed on the computer device 150-1. The management server communicates the synthesized device information 145 to image loader resource 160.

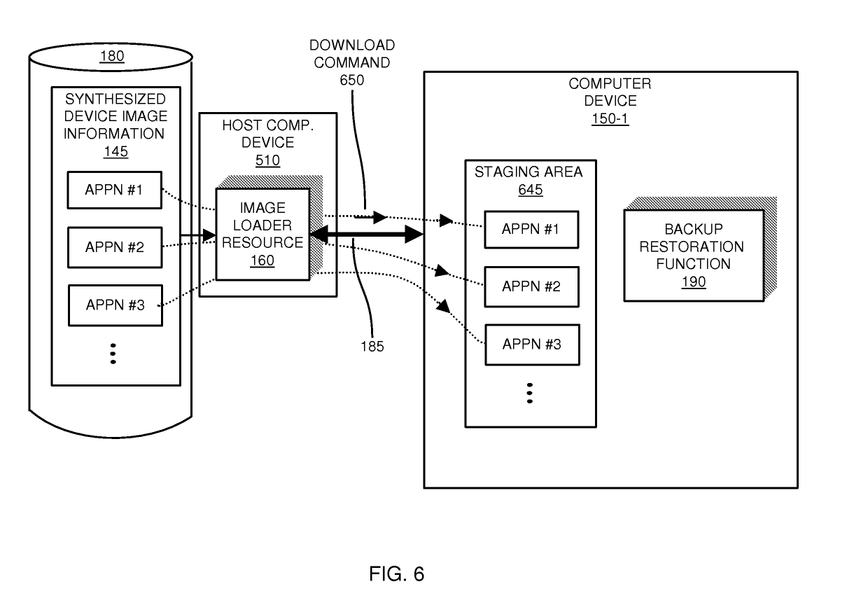

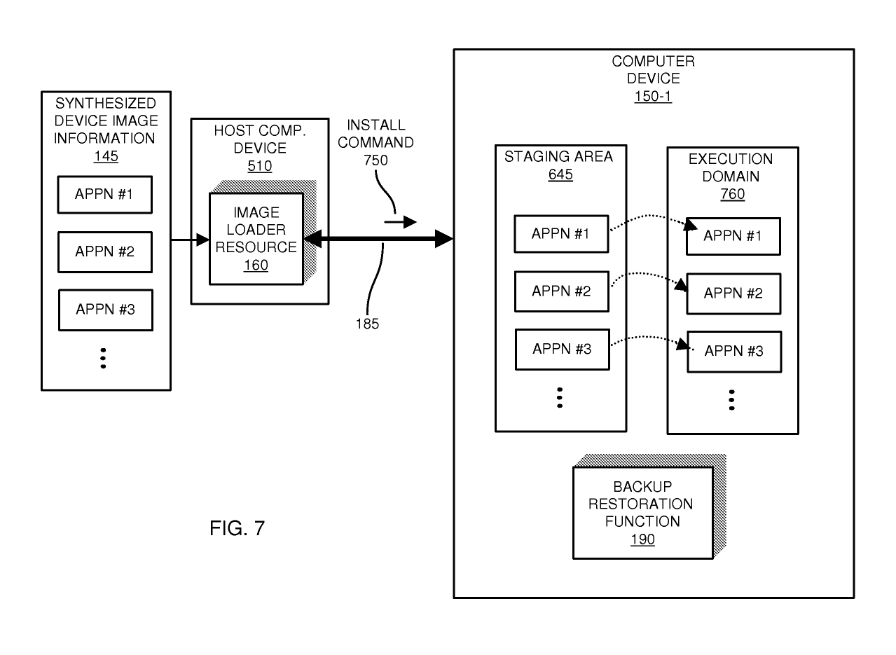

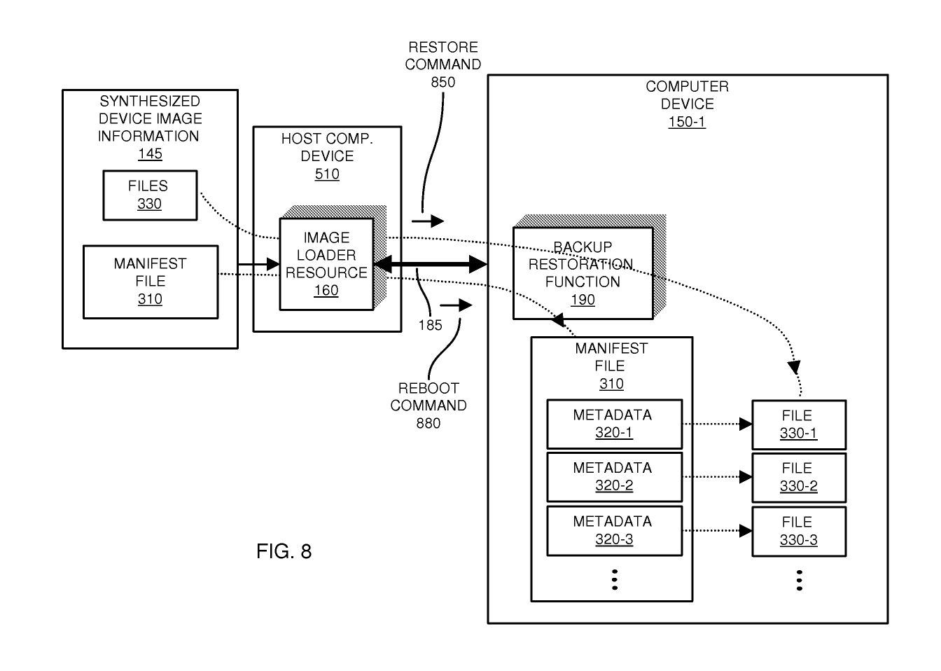

In one embodiment, multiple applications may already be installed on the computer device 150-1. In such an instance, the image loader resource 160 identifies free and/or specifically allocated storage space in the computer device 150-1 in which to install the new application using the synthesized device image information 145 generated by image creator resource 145. In a manner as described herein, the image loader resource 160 then initiates download (FIG. 6), installation (FIG. 7), and restore (FIG. 8) commands to copy the new application onto computer device 150-1.

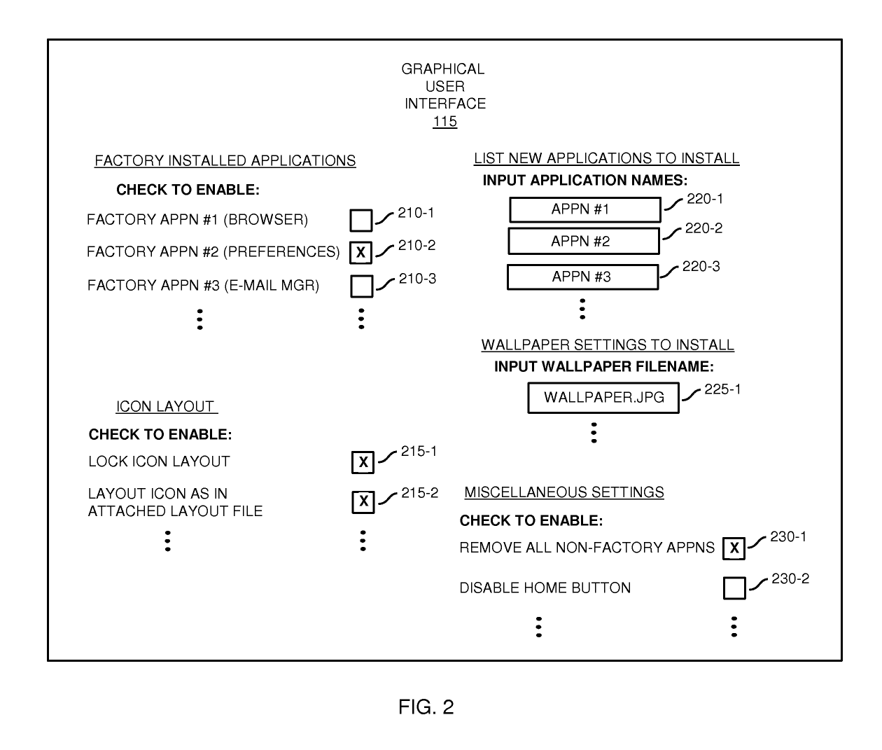

FIG. 2 is an example diagram illustrating a graphical user interface to input computer configuration information according to embodiments herein.

As shown, the graphical user interface 115 can include a number of different setting options for selection by the user 108. For example, a target computer device to be configured can include one or more factory installed applications (such as applications installed by a manufacturer of the device or operating system in the device) such as factory application #1 (such as a browser), factory application #2 (such as preferences manager), factory application #3 (such as an e-mail manager), etc.

In general, these manufacturer-installed applications may be stored in a storage location of the target computer device that is not accessible to the administrator or user of the target computer device.

Embodiments herein enable a respective administrator to indicate which of the factory-installed applications are to be activated for use by a user of the target computer device. In this example embodiment, the user 108 checks box 210-2 in graphical user interface 115, indicating that the factory installed application #2 should be activated for use upon subsequent reconfiguration. The user 108 does not check box 210-1 or box 210-3 in graphical user interface 115, indicating that these factory-installed applications #1 and #3 will not be activated or enabled for use on the computer device.

Graphical user interface 115 further enables the respective user 108 to control icon information in a target computer device to be configured. For example, the user 108 selects box 215-1 to lock the icon layout so that the user is unable to change the icon layout. The user 108 selects box 215-2 to indicate that the target computer device is to be configured in accordance with an attached layout file provided as input by the user 108. The user 108 inputs the icon layout file to an appropriate repository to indicate how to layout the icons that will appear on the display screen of the target computer device upon subsequent use. The layout file indicates how to configure a visual layout of icons on a target computer device.

The graphical user interface 115 enables a respective user to specify which of one or more applications is to be installed on the target computer device during configuration or re-configuration. In this example, as shown in graphical user interface 115, the user 108 inputs application information such as a name of application #1 in respective data field 220-1, name of application #2 in data field 220-2, name of application #3 in data field 220-3, etc. In addition to specifying names of applications to download and install onto the target computer device, the user 108 operating graphical user interface 115 also provides a copy of the executable binary code associated with any such specified applications. The user 108 inputs the applications to be downloaded and installed on the target computer device(s).

The graphical user interface 115 also enables a respective user 108 to specify one or more wallpaper settings to display on the display screen of the target computer device during use of the target computer device. In one embodiment, the user 108 provides a copy of the wallpaper (e.g., a file including the wallpaper) as well as inputs a name of the respective file to be used as the wallpaper in data field 225-1. Via further input to the graphical user interface 115, the user is able to indicate when and/or where the wallpaper is to be applied in the target computer device.

Graphical user interface 115 also enables a respective user 108 to control additional aspects of configuring a respective target computer device. For example, under miscellaneous settings, the user 108 can check box 230-1 to remove all non-factory applications installed on the target computer device when performing a subsequent reconfiguration. Non-factory installed applications are applications that a previous user of the target computer device downloads and installs onto the target computer device prior to being reconfigured using the synthesized device image information 145 as discussed herein. In one non-limiting example embodiment, the user 108 can check box 230-2 to disable the home button of the computer device when performing a subsequent reconfiguration.

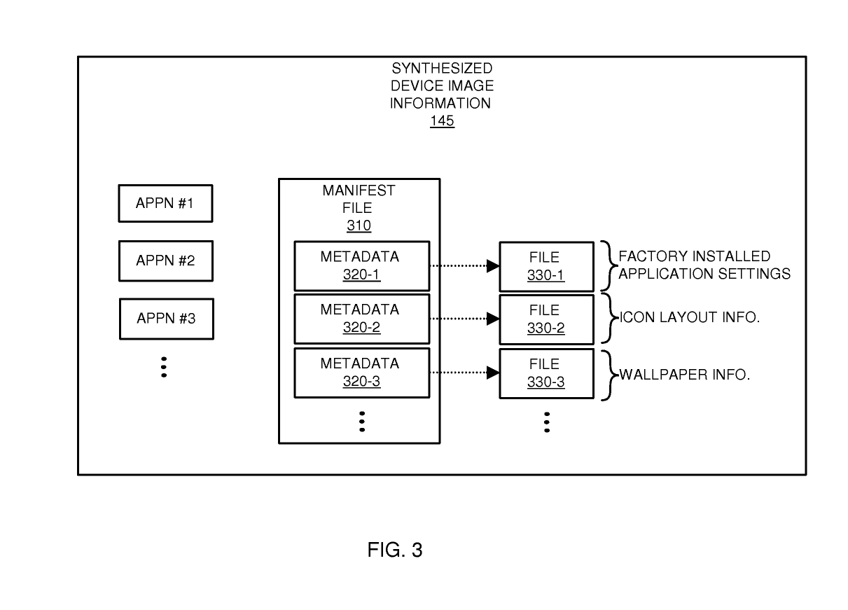

FIG. 3 is an example diagram illustrating synthesized device image information according to embodiments herein.

As shown, synthesized device image information 145 can include executable applications (e.g., application #1, application #2, application #3, etc.), manifest file 310, and files 330 (e.g., file 330-1, file 330-2, file 330-3, etc.).

The manifest file 310 is a list that specifies the resources such as files, data, etc., to be used by the respective backup restoration function to configure a respective target computer device.

In one non-limiting example embodiment, each of the files 330 includes different settings information to be applied to the target computer device to be configured.

For example, file 330-1 can include information specifying settings for the one or more factory-installed applications (e.g., phone service, . . . ) on the target computer device. The settings information in file 330-1 can indicate which of the factory-installed applications to enable, which of the factory-installed applications to enable, which of the factory-installed applications to disable, etc. For disabled applications, the backup restoration function in the target computer device does not remove the factory-installed applications. Instead, the settings prevent display of the corresponding icon to a user and prevent any other software resource from launching the disabled application.

As shown, file 330-2 can include information specifying settings for icon layout on the target computer device to be configured. File 330-3 can include information specifying wallpaper information to be used on the target computer device to be configured.

In this manner, the manifest file 310 can include a respective reference to any of multiple files 330.

Note that the manifest file 310 can include metadata associated with each of the files 330. For example, manifest file 310 includes metadata 320-1 associated with file 330-1; manifest file 310 includes metadata 320-2 associated with file 330-2; manifest file 310 includes metadata 320-3 associated with file 330-3; and so on.

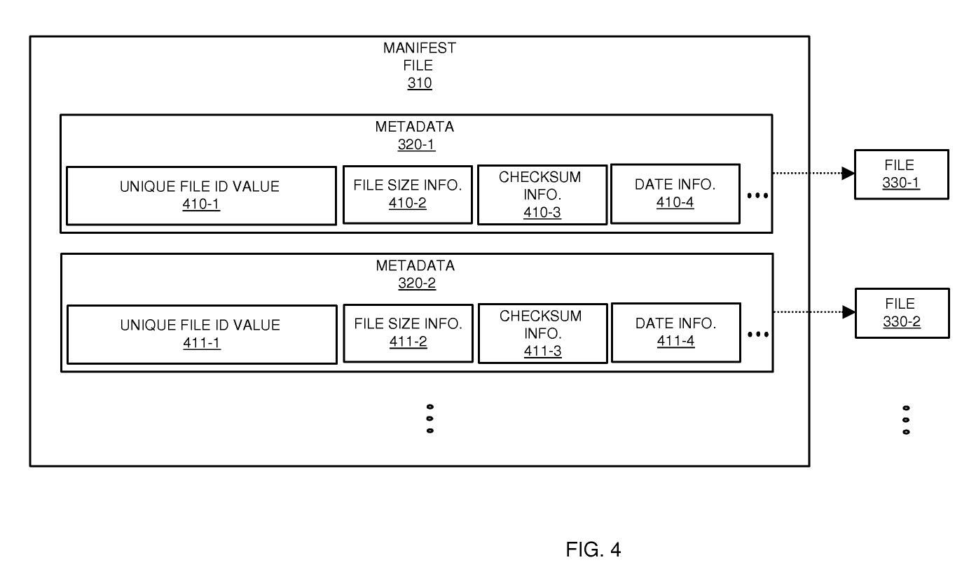

FIG. 4 is an example diagram illustrating a manifest file and corresponding metadata according to embodiments herein.

A previously discussed, embodiments herein include converting the input 105 from user 108 into respective synthesized device image information 145. The synthesized device image information 145 includes a manifest file 145 and multiple settings files 330 configured in accordance with the input 105. The manifest file 310 indicates availability of the multiple files 330 in the synthesized device image information 145.

The manifest file 310 can include metadata 320-1. In this non-limiting example embodiment, the metadata 320-1 includes a unique file identifier value 410-1, file size information 410-2, checksum information 410-3, date information 410-4, and so on.

In one embodiment, the unique file identifier value 410-1 is a hash value derived from file 330-1; file size information 410-2 specifies a size (such as number of bytes) of file 330-1; checksum information 410-3 is a checksum of the contents of file 330-1; date information 410-4 specifies the date of when file 330-1 was created or last saved, file-system flags, and so on.

As shown and previously discussed, manifest file 310 also can include metadata 320-2. In this non-limiting example embodiment, the metadata 320-2 includes metadata associated with file 330-2 such as a unique file identifier value 411-1, file size information 411-2, checksum information 411-3, date information 411-4, and so on.

In one embodiment, the unique file identifier value 411-1 is a hash value derived from file 330-2; file size information 411-2 specifies a size (such as number of bytes) of file 330-2; checksum information 411-3 is a checksum of the contents of file 330-2; date information 410-4 specifies the date of when file 330-2 was last saved, and so on.

In this manner, the manifest file 310 can indicate resources to be used to reconfigure a respective target computer device. Also, as discussed, the metadata 320 in the manifest file 310 includes information about the files 330.

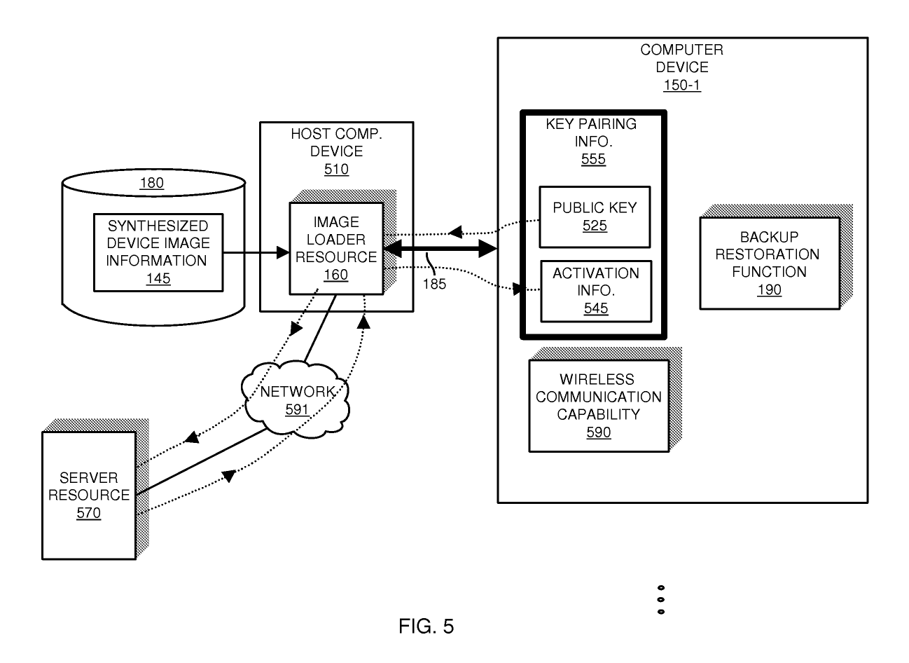

FIG. 5 is a diagram illustrating example configuration of a respective target computer device according to embodiments herein. Each of multiple target computer devices can be configured in a similar manner.

Initially, the computer device 150-1 is plugged into a physical link such as a cable extending between the host computer device 510 and the target computer device 150-1. As an alternative to a physical cable, the communication link 185 can be a wireless link.

By way of a non-limiting example, the image loader resource 160 of the host computer device 510 can initiate creation of a secured socket connection between the host computer device 510 and the target computer device. In accordance with a lockdown handshake protocol, the image loader resource 160 establishes the communication link 185 over a suitable communication medium between the image loader resource 160 and the computer device 150-1 to be configured.

In certain instances, the target computer device 150-1 to be configured may have wireless communication capability 590 such as cellular phone capability. The wireless communication capability 590 enables a respective user of the target computer device 150-1 to communicate using a respective wireless link supported by a third-party carrier such as a cell phone service provider.

In this non-limiting example embodiment, via communications over the communication link 185, assume that the image loader resource 160 detects that wireless communication capability 590 associated with the target computer device 150-1 has not yet been activated. Recall that the target computer device 150-1 may be a new device that has never been configured.

In such an instance, to activate the wireless communication capability 590 in the target computer device 150-1, the image loader resource 160 initiates retrieval of the public key 525 assigned to the target computer device 150-1. In one embodiment, the target computer device 150-1 is hard-coded with public key 525 such as a unique public key value.

In response to a request from the image loader resource 510, the target computer device 150-1 forwards the public key 525 over communication link 185 to the image loader resource 160. The image loader resource 160 forwards the public key 525 over network 591 (such as the Internet) to server resource 570 such as an activation server. The server resource 570 can be or include functionality provided by a respective wireless communication service provider that is to support the wireless communication capability 590 of the computer device 150-1.

Subsequent to forwarding the public key 525 to the server resource 570, the image loader resource 160 receives an activation response message from the server resource 570 over network 591. In one embodiment, the server resource 570 uses the public key 525 to produce activation information 545. The server resource 570 forwards the activation information 545 in a communication or message over network 591 to image loader resource 160.

In furtherance of activating wireless communication capability 590, the image loader resource 160 forwards the activation information 545 (e.g., as an activation response message) received from the server resource 570 to the target computer device 150-1 to activate the wireless communication capability 590 in computer device 150-1. The target computer device 150-1 uses the activation information 545 to activate the wireless communication capability 590 in the target computer device 150-1.

Via these communications over communication link 185, the image loader resource 160 is able to perform automatic activation of communication services (such as phone services) over communication link 185 so that the subsequent user of the target computer device 150-1 does not need to manually perform such an operation.

In one embodiment, the activation information 545 includes authentication/identification information either in place of or in addition to cryptographic keys. The public key 525 and the activation information 545 represent key pairing information stored in the target computer device 150-1. The key pairing information 555 can support additional functions such as talking to secure on-board services such as ManagedConfiguration or lockdown.

FIG. 6 is a diagram illustrating example configuration of a respective target computer device via downloading of one or more executable application files and data according to embodiments herein.

As previously discussed, the communication link 185 can be a lockdown Transmission Control Protocol type connection or link supporting secured communications between the image loader resource 160 and the computer device 150-1. In one embodiment, subsequent to establishing the communication link 185 with the target computer device 150-1, the image loader resource 160 creates an application folder in staging area 645 of computer device 150-1. The image loader resource 160 then initiates transmission of each of the installable applications (APPN#1, APPN#2, APPN#3, etc.) over the communication link 185 for storage in a staging area of the target computer device 150-1. As mentioned, the synthesized device image information 145 can include the software executable applications and installation resources needed to install the applications onto a respective computer device.

FIG. 7 is a diagram illustrating example installation of applications on a respective target computer device according to embodiments herein.

As previously discussed, the image loader resource 160 initiates storage of installable application #1, installable application #2, installable application #3, etc., in staging area 645. Subsequent to downloading, the image loader resource 160 initiates installation of the applications onto computer device 150-1 as executable applications #1, #2, #3, etc. As mentioned, each of the applications can include corresponding installation software to install a respective application on a target computer device.

As shown, the image loader resource 160 transmits an install command 750 over communication link 185 to install the applications in the staging area 645 onto the target computer device 150-1. In response to receiving the install command 750, the computer device 150-1 initiates installation of the applications #1, #2, #3, etc., into execution domain 760. Subsequent to installation (and reboot), executable applications #1, #2, #3, etc., in execution domain 760 are available for execution by a respective user operating the computer device 150-1. The reboot command may not occur until further processing as discussed in FIG. 8.

FIG. 8 is a diagram illustrating example configuration of a respective target computer device according to embodiments herein.

As previously discussed, the synthesized device image information 145 also includes a manifest file 310 and corresponding configuration files 330. In furtherance of configuring the computer device 150-1, the image loader resource 160 can be configured to transmit a restore command over the communication link 850 to the backup restoration function 190. In response to receiving the restore command 850, the backup restoration function 190 generates a request for the manifest file 310 over communication link 185 to the image loader resource 160.

In response to transmitting the restore command 850 to backup restoration function 190, the image loader resource 160 receives the request from the backup restoration function for the manifest file 310 associated with the synthesized device image information 145. As previously discussed, the manifest file 310 specifies one or more files 330 that are further used to configure the target computer device 150-1.

The image loader resource 160 transmits the manifest file 310 over the communication link 185 to the backup restoration function 190.

The backup restoration function 190 processes and uses the manifest file 310 to identify the files 330 to retrieve from image loader resource 160 to configure the computer device 150-1. For example, the backup restoration function 190 processes the metadata 320-1 in manifest file 310 to identify and retrieve file 330-1. In one embodiment, the image loader resource 160 receives a request from the backup restoration function 190 for file 330-1 (e.g., a first file as specified in the manifest file 310). The backup restoration function 190 can use any suitable identifier value to specify the file 330-1. In response to receiving the request, the image loader resource 160 initiates transmission of the file 330-1 over the communication link 185 to the backup restoration function 190.

Additionally, the backup restoration function 190 processes the metadata 320-2 in manifest file 310 to identify and retrieve file 330-2. In one embodiment, the image loader resource 160 receives a request from the backup restoration function 190 for file 330-2 (e.g., a second file as specified in the manifest file 310). In response to receiving the request, the image loader resource 160 initiates transmission of the file 330-2 over the communication link to 185 the backup restoration function 190.

Yet further, the backup restoration function 190 processes the metadata 320-3 in manifest file 310 to identify and retrieve file 330-3. In one embodiment, the image loader resource 160 receives a request from the backup restoration function 190 for file 330-3 (e.g., a third file as specified in the manifest file 310). In response to receiving the request, the image loader resource 160 initiates transmission of the file 330-3 over the communication link 185 to the backup restoration function 190.

In this manner, the backup restoration function 190 uses the manifest file 310 to identify and retrieve the configuration files 330.

In one embodiment, as previously discussed, the image creator resource 140 produces the manifest file 310 to include a digest value associated with each of files 330. For example, recall that the image creator resource 140 applies a function (such as a hash function) to file 330-1 to produce a unique file identifier value 410-1 or digest value (such as a hash value) for file 330-1. The image creator resource 140 includes the digest value (unique file identifier value 410-1) for file 330-1 in manifest file 310.

In a similar manner, the image creator resource 140 produces the manifest file 310 to include a respective digest value (e.g., unique file identifier value) for each of the files 330 specified in the manifest file 310.

In one embodiment, the backup restoration function 190 processes each of the received files 330 to determine whether the files 330 have been corrupted, improperly modified, etc. For example, the backup restoration function 190 can be configured to apply a hash function to contents of received file 330-1 to produce a hash value for the file 330-1. The backup restoration function 190 compares the produced hash value to unique file identifier value 410-1 (such as a hash value) for file 330-2 stored in the manifest file 310 for file 330-1. If the produced hash value matches the hash value stored in the manifest file 310, the file 330-1 passes this first level check. In the event that there is not a match, the backup restoration function 190 assumes that the file 330-1 is corrupt or tampered with.

The backup restoration function 190 can be configured to perform additional checks to determine whether each of the files 330 has been corrupted, improperly modified, etc. For example, recall that metadata 320-1 associated with file 330-1 includes file size information 410-2, checksum information 410-3, date information 410-4, etc. By further way of a non-limiting example, the backup restoration function 190 can be configured to compare a size of the file 330-1 retrieved over communication link 185 to the file size information 410-2 in metadata 320-1. The two values should match. If not, the backup restoration function 190 flags this as an error and prevents configuration using the file 330-1.

As another possible check, the backup restoration function 190 can be configured to apply a checksum algorithm to the file 330-1 received over the communication link 185. The backup restoration function 190 compares the produced checksum value to the checksum information 410-3 stored in metadata 320-1. The two values should match. If not, the backup restoration function 190 flags this as an error and prevents configuration using the file 330-1.

As yet another possible check, the backup restoration function 190 can be configured to obtain a date value associated with the file 330-1 received over the communication link 185. The backup restoration function 190 compares the date value to the date information 410-4 stored in metadata 320-1. The two values should match. If not, the backup restoration function 190 flags this as an error and prevents configuration using the file 330-1.

The backup restoration function 190 can be configured to apply the multi-level checks to each of the files as specified by the manifest file 310. For example, the backup restoration function 190 can be configured to apply a hash function to file 330-2 to produce a hash value for the file 330-2. The backup restoration function 190 compares the produced hash value to a hash value (such as unique file identifier value 411-1) stored in the manifest file 310 for the file 330-2. If the produced hash value matches the hash value (such as unique file identifier value 411-2) for file 330-2 stored in the manifest file 310, the file 330-2 passes this first level check. If not, the backup restoration function 190 flags this as an error and prevents configuration using the file 330-2.

The backup restoration function 190 can be configured to perform additional checks to determine whether the file 330-2 has been corrupted, improperly modified, etc. For example, recall that metadata 320-2 associated with file 330-2 further includes file size information 411-2, checksum information 411-3, date information 411-4, etc. By further way of a non-limiting example, the backup restoration function 190 can be configured to compare a size of the file 330-2 retrieved over communication link 185 to the file size information 411-2 in metadata 320-2. The two values should match. If not, the backup restoration function 190 flags this as an error and prevents configuration using the file 330-2.

As another possible check, the backup restoration function 190 can be configured to apply a checksum algorithm to the file 330-2 received over the communication link 185. The backup restoration function 190 compares the produced checksum value (based on application of the checksum algorithm) to the checksum information 411-3 stored in metadata 320-1. The two values should match. If not, the backup restoration function 190 flags this as an error and prevents configuration using the file 330-2.

As yet another possible check, the backup restoration function 190 can be configured to obtain a date value associated with the file 330-2 received over the communication link 185. The backup restoration function 190 compares the date value to the date information 411-4 stored in metadata 320-2. The two values should match. If not, the backup restoration function 190 flags this as an error and prevents configuration using the file 330-2.

In a similar manner, the backup restoration function 190 can be configured to perform a multi-level check on each configuration file.

Subsequent to verification of files 330 and application of settings in the files 330 by the backup restoration function 190, the image loader resource 160 (or other suitable resource) generates a reboot command 880 to the computer device 150-1. In response to the reboot command, the computer device 150-1 restarts using the new configuration settings as specified by synthesized device image information 145.

As previously discussed, the computer device 150-1 can be any suitable type of resource such as an iOS™ type of computer device, Android™ computer device, etc. The computer configuration instructions 125 and synthesized device image information 145 indicate how to produce a device image for the iOS™ type of computer device, Android™ computer device, etc.

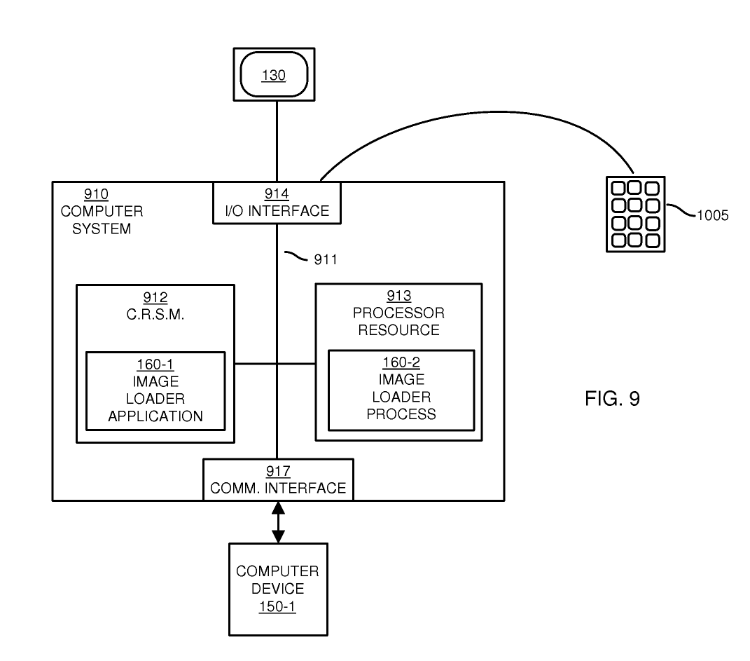

FIG. 9 is an example block diagram of a computer hardware system for executing operations according to embodiments herein. Any of the functionality and/or resources as discussed herein (e.g., image designer resource 120, image creator resource 140, image loader resource 160, backup restoration function 190, backup restoration function 191, etc.) can be executed with computer system 910 or the like to perform functionality as discussed herein.

Computer system 910 (e.g., computer hardware, software, etc.) can be or include one or more computerized devices such as a mobile computer device, personal computer, workstation, portable computing device, mobile device, handheld device, console, network terminal, processing device, network device, etc. In one embodiment, computer system 910 represents host computer device 510 operated to configure one or more target computer devices.

Note that the following discussion provides a basic embodiment indicating how to execute functionality according to embodiments herein using a computer system. However, it should be noted that the actual configuration for carrying out the operations as described herein can vary depending on a respective application.

As shown, computer system 910 of the present example includes an interconnect 911 that couples computer readable hardware storage media 912 (i.e., a non-transitory type of computer readable storage media) in which digital information can be stored and/or retrieved, a processor resource 913 (e.g., one or more processor devices), I/O interface 914, a communications interface 917, etc.

I/O interface 914 provides connectivity to different resources such as a repository, display screen, keyboard, computer mouse, etc.

Computer readable hardware storage medium 912 can be any suitable device such as memory, optical storage, hard drive, floppy disk, etc. In one embodiment, the computer readable storage medium 912 is a non-transitory computer readable storage media (i.e., any hardware storage media ort medium) to store instructions and/or data.

Communications interface 917 enables the computer system 910 and processor device 913 to communicate over a network to retrieve information from remote sources and communicate with other computers. In one embodiment, the I/O interface 914 enables processor device 913 to retrieve respective information from a repository.

As shown, computer readable storage media 912 can be encoded with image loader application 160-1 (e.g., software, firmware, etc.) executed by processor resource 913.

During operation of one embodiment, processor device 913 (e.g., one or more computer devices) accesses computer readable storage media 912 via the use of interconnect 911 in order to launch, run, execute, interpret or otherwise perform the instructions of image loader application 160-1 stored on computer readable storage medium 912. Image loader application 160-1 can include appropriate instructions, logic, etc., to carry out any or all functionality associated with the resources (e.g., clients, servers, notification network, network administrator, etc.) in a computer network environment as discussed herein.

Execution of the image loader application 160-1 produces processing functionality such as image loader process 160-2 in processor resource 913. In other words, the image loader process 160-2 associated with image loader resource 913 represents one or more aspects of executing image loader application 160-1 within or upon the processor resource 913 in the computer system 910.

Those skilled in the art will understand that the computer system 910 can include other processes and/or software and hardware components, such as an operating system that controls allocation and use of hardware resources to execute image loader application 160-1.

In accordance with different embodiments, note again that computer system 910 may be any of various types of devices, including, but not limited to, a mobile computer device, personal computer system, desktop computer, laptop, notebook, netbook computer, mainframe computer system, handheld computer, workstation, network computer, application server, storage device, a consumer electronics device such as a camera, camcorder, set top box, mobile device, portable handheld device, video game console, handheld video game device, a peripheral device such as a switch, modem, router, or in general any type of computing or electronic device.

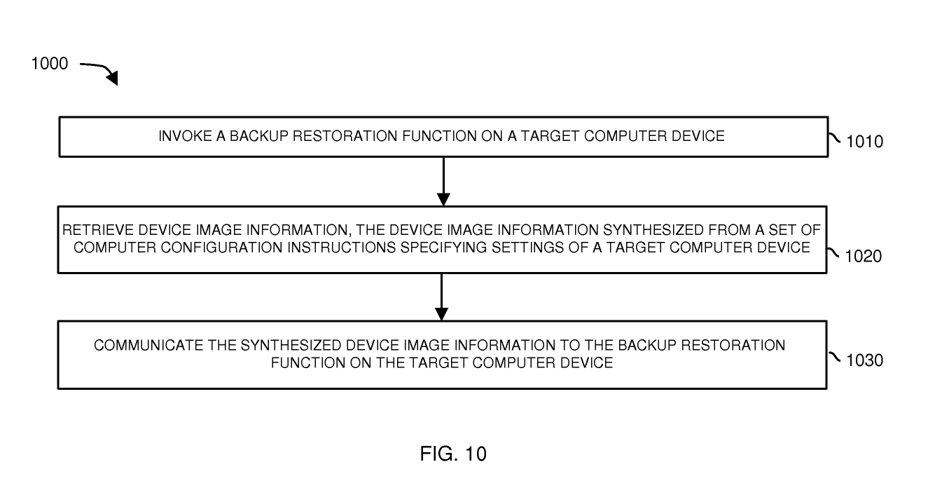

Functionality supported by resources in processing environment 100 will now be discussed via flowchart 1000 in FIG. 10. Note that there will be some overlap with respect to concepts discussed above for FIGS. 1 through 9. Also, note that the steps in the below flowcharts need not always be executed in the order shown. That is, the steps can be executed in any suitable order.

FIG. 10 is a flowchart illustrating an example method facilitating configuration of a computer device according to embodiments herein.

In processing block 1010 of flowchart 1000, the image loader resource 160 invokes a backup restoration function 190 on a target computer device 150-1.

In processing block 1020, the image loader resource 160 retrieves synthesized device image information 145. In one embodiment, the device image information is synthesized from a set of computer configuration instructions 125 specifying settings to be applied to target computer device 150-1.

In processing block 1030, the image loader resource 160 communicates the synthesized device image information 145 to the backup restoration function 190 on the target computer device 150-1.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting. Rather, any limitations to the invention are presented in the following claims.

We claim:

1. A method comprising:
retrieving device image information, the device image information synthesized from a set of computer configuration instructions specifying settings of a target computer device; communicating the synthesized device image information to the target computer device; and
invoking a backup restoration function on the target computer device to load the synthesized device image information onto the target computer device.

2. The method as in claim 1 further comprising:
receiving the set of computer configuration instructions; and
creating the synthesized device image information in a manner as specified by the set of computer configuration instructions.

3. The method as in claim 2 further comprising:
deriving the set of computer configuration instructions from data inputted by an administrator through a graphical user interface, the administrator controlling configuration of the target computer device via the specified settings.

4. The method as in claim 1, wherein the backup restoration function in the target computer device applies the synthesized device image information to the target computer device to modify the settings of the target computer device.

5. The method as in claim 1, wherein the target computer device is a new computer device yet-to-be distributed for use by a target user, the method further comprising:
spoofing the backup restoration function that the synthesized device image information is a backup device image to be applied to the target computer device.

6. The method as in claim 1 further comprising;
invoking a respective backup restoration function in each of multiple target computer devices; and
communicating the synthesized device image information to each of the respective backup restoration functions.

7. The method as in claim 1, wherein an administrator resource of an organization overseeing use of the target computer device produces the set of computer configuration instructions specifying the settings of the target computer device.

8. The method as in claim 7 further comprising:
converting the set of computer configuration instructions produced by the administrator resource into the device image information, the device image information including a manifest file and multiple settings files configured in accordance with the set of computer configuration instructions, the manifest file indicating availability of the multiple files in the device image information.

9. The method as in claim 1 further comprising:
subsequent to communicating the synthesized device image information to the backup restoration function on the target computer device, initiating a reboot of the target computer device to activate the settings as specified by the device image information.

10. The method as in claim 1 further comprising:
via communications with the target computer device, detecting that wireless communication capability associated with the target computer device has not yet been activated;
retrieving a public key assigned to the target computer device;
forwarding the public key to an activation server;
receiving an activation response message from the activation server; and
forwarding the activation response message received from the activation server to the target computer device to activate the wireless communication capability.

11. The method as in claim 1 further comprising:
establishing a communication link with the target computer device;
transmitting an application over the communication link for storage in a staging area of the target computer device; and
communicating over the communication link to install the application in the staging area onto the target computer device.

12. The method as in claim 11 further comprising:
transmitting a restore command over the communication link to the backup restoration function;
in response to transmitting the restore command, receiving a request from the backup restoration function for a manifest file associated with the device image information, the manifest file specifying files to configure the target computer device; and
transmitting the manifest file to the backup restoration function.

13. The method as in claim 12 further comprising:
receiving a first request from the backup restoration function, the first request requesting retrieval of a first file as specified in the manifest file;
in response to receiving the first request, initiating transmission of the first file over the communication link to the backup restoration function;
receiving a second request from the backup restoration function, the second request requesting retrieval of a second file as specified in the manifest file;
in response to receiving the second request, initiating transmission of the second file over the communication link to the backup restoration function.

14. The method as in claim 12 further comprising:
producing the manifest file to include a respective hash value for each of the files specified in the manifest file.

15. The method as in claim 1, wherein the target computer device is an iOS™ type of device; and
wherein the set of instructions indicates how to produce the device image for the iOS™ type of device.

16. A computer hardware system comprising:
processor hardware;
a repository that physically stores instructions associated with an application executed by the processor hardware; and
an interconnect coupling the processor hardware and the repository, the interconnect causing the processor hardware to execute the application and perform operations of:
retrieving device image information, the device image information synthesized from a set of computer configuration instructions specifying settings of a target computer device; and
communicating the synthesized device image information to a backup restoration function on the target computer device; and
invoking a backup restoration function on the target computer device to load the synthesized device image information onto the target computer device.

17. The computer hardware system as in claim 16, wherein the processor hardware executes the application and performs further operations of:
receiving the set of computer configuration instructions; and
creating the synthesized device image information in a manner as specified by the set of computer configuration instructions.

18. The computer hardware system as in claim 17, wherein the processor hardware executes the application and performs further operations of:
deriving the set of computer configuration instructions from data inputted by a network administrator through a graphical user interface, the network administrator controlling configuration of the target computer device via the specified settings.

19. The computer hardware system as in claim 16, wherein the backup restoration function in the target computer device applies the synthesized device image information to the target computer device to modify the settings of the target computer device.

20. The computer hardware system as in claim 16, wherein the target computer device is a new computer device yet-to-be distributed for use by a target user, the processor hardware executes the application and performs further operations of:
spoofing the backup creation function that the synthesized device image information is a backup device image to be applied to the target computer device.

21. The computer hardware system as in claim 16, wherein the processor hardware executes the application and performs further operations of:
invoking a respective backup restoration function in each of multiple target computer devices; and
communicating the synthesized device image information to each of the respective backup restoration functions.

22. The computer hardware system as in claim 16, wherein an administrator resource of an organization overseeing use of the target computer device produces the set of computer configuration instructions specifying the settings of the target computer device.

23. The computer hardware system as in claim 22, wherein the processor hardware executes the application and performs further operations of:
converting the set of computer configuration instructions produced by the network administrator into the device image information, the device image information including a manifest file and multiple settings files configured in accordance with the set of computer configuration instructions, the manifest file indicating availability of the multiple files in the device image information.

24. The computer hardware system as in claim 16, wherein the processor hardware executes the application and performs further operations of:
subsequent to communicating the synthesized device image information to the backup restoration function on the target computer device, initiating a reboot of the target computer device to activate the settings as specified by the device image information.

25. The computer hardware system as in claim 16, wherein the processor hardware executes the application and performs further operations of:
via communications with the target computer device, detecting that wireless communication capability associated with the target computer device has not yet been activated;
retrieving a public key assigned to the target computer device;
forwarding the public key to an activation server;
receiving an activation response message from the activation server; and
forwarding the activation response message received from the activation server to the target computer device to activate the wireless communication capability.

26. The computer hardware system as in claim 16, wherein the processor hardware executes the application and performs further operations of:
establishing a communication link with the target computer device;
transmitting an application over the communication link for storage in a staging area of the target computer device; and
communicating over the communication link to install the application in the staging area onto the target computer device.

27. The computer hardware system as in claim 26, wherein the processor hardware executes the application and performs further operations of:
transmitting a restore command over the communication link to the backup restoration function;
in response to transmitting the restore command, receiving a request from the backup restoration function for a manifest file associated with the device image information, the manifest file specifying files to configure the target computer device; and
transmitting the manifest file to the backup restoration function.

28. The computer hardware system as in claim 27, wherein the processor hardware executes the application and performs further operations of:
receiving a first request from the backup restoration function, the first request requesting retrieval of a first file as specified in the manifest file;
in response to receiving the first request, initiating transmission of the first file over the communication link to the backup restoration function;
receiving a second request from the backup restoration function, the second request requesting retrieval of a second file as specified in the manifest file;
in response to receiving the second request, initiating transmission of the second file over the communication link to the backup restoration function.

29. The computer hardware system as in claim 27, wherein the processor hardware executes the application and performs further operations of:
producing the manifest file to include a respective hash value for each of the files specified in the manifest file.

30. The computer hardware system as in claim 16, wherein the target computer device is an iOS™ type of device; and
wherein the set of instructions indicates how to produce the device image for the iOS™ type of device.

31. A computer-readable hardware storage medium having instructions stored thereon for processing data information, such that the instructions, when carried out by at least one processing device, cause the at least one processing device to perform operations of:
invoking a backup restoration function on a target computer device;
retrieving device image information, the device image information synthesized from a set of computer configuration instructions specifying settings of a target computer device; and
communicating the synthesized device image information to the backup restoration function on the target computer device.
